(19) United States
(12) Patent Application Publication
(10) Pub. No.: US 2023/0185366 A1
(43) Pub. Date: Jun. 15, 2023

(54) System for interacting with a plurality of visual zones and interaction assembly in the cockpit of an aircraft comprising such an interaction system

(71) Applicant: THALES, COURBEVOIE (FR)

(72) Inventor: Stéphanie LAFON, MERIGNAC (FR)

(21) Appl. No.: 17/923,224

(22) PCT Filed: May 5, 2021
(86) PCT No.: PCT/EP2021/061810

§ 371 Date: Nov. 3, 2022

(30) Foreign Application Priority Data
May 5, 2020 (FR) 2004435

(51) Int. Cl. G06F 3/01; G06F 3/16; G10L 15/22

(52) U.S. Cl. CPC G06F 3/012; G06F 3/013; G06F 3/167; G10L 15/22; G10L 2015/223

(57) ABSTRACT

A system for interacting with a plurality of visual zones, including a measurement module apt to generate a set of measurements characterizing every position and/or orientation of at least a part of the pilot’s body in a predetermined motor space, a pointing module apt to designate an active visual zone in a visual space using a transfer function, the transfer function associating every set of measurements with an identifier of one of the visual zones of the visual space, and an output module apt to send to a display unit associated with the active visual zone, an activation signal indicating the designation of the zone.

### CROSS-REFERENCE TO RELATED APPLICATIONS

This application claims benefit under 35 USC §371 of PCT Application No. PCT/EP2021/061810 entitled SYSTEM FOR INTERACTING WITH A PLURALITY OF VISUAL ZONES AND INTERACTION ASSEMBLY IN THE COCKPIT OF AN AIRCRAFT COMPRISING SUCH AN INTERACTION SYSTEM, filed on May 5, 2021 by inventor Stephanie Lafon. PCT Application No. PCT/EP2021/061810 claims priority of French Patent Application No. 20 04435, filed on May 5, 2020.

### FIELD OF THE INVENTION

The present invention relates to a system for interacting with a plurality of visual zones.

The present invention further relates to an interaction system in the cockpit of an aircraft comprising such an interaction system.

The field of the invention is the field of means of interaction, in the cockpit of an aircraft, with visual zones, such as display screens.

### BACKGROUND OF THE INVENTION

In the prior art, many means of interaction with such visual zones are already known.

Conventionally, the interaction with the visual zones of the aircraft cockpit takes place directly. Such type of interaction comprises in particular a direct press on buttons, a rotation of wheels or pressing on touch screens.

However, such interactions are not always appropriate for all the circumstances of a flight. In particular, in the event of turbulence or complicated piloting situations, direct interaction with the corresponding means of interaction can be made difficult or even impossible in certain cases.

To solve such problems, usually, the crew distributes the tasks so as to enable the person who has to pilot to be dispensed of other actions which require direct manual interactions.

However, such an approach imposes many restrictions on the distribution of tasks between pilots. Such restrictions can make the distribution non-optimal. Moreover, such approach requires that the crew consist of at least two pilots, which may not be consistent with new trends in reducing the number of crew elements.

It is thus obvious that future means of interaction have to enable the crew to interact with visual zones indirectly and independently of each piloting situation even when the situation is complicated situation.

In the prior art, means of indirect interaction with at least some visual zones of the cockpit of the aircraft are already known.

Among such means of interaction, there are in particular means of pointing by gaze, which make it possible to move a cursor displayed on the visual zones of the cockpit, by following the pilot’s gaze.

However, according to recent studies, gaze is not always the best means of indirect control in the cockpit.

Means of indirect interaction by voice are also known, which are used for controlling the visual zones of the cockpit according to voice commands given by the pilot.

However, such means of indirect interaction are not optimal either because it is not always possible to interpret with certainty the voice commands given by the pilot. Moreover, the use of voice commands does not always make it possible to optimally designate an active zone.

Finally, indirect means of interaction are for indicating an interactive zone, e.g. by a movement of the pilot’s head, are also known. Such a system is described in the document FR 1872329 of the Applicant.

In particular, the means of interaction described in said document makes it possible to designate using the head, the interactive zones in augmented reality [with] a continuity of interaction at head-down. The continuous designation is performed using an designation target displayed in augmented reality, e.g. in the pilot’s helmet. Said target follows the movement of the head and can designate any zone of interaction in augmented reality or on the actual cockpit screens.

However, such means of interaction do not allow the pilot to interact with the corresponding visual zones easily.

Indeed, in certain cases, the interaction with at least certain virtual zones comes up against articulation constraints of the pilot. In some other cases, the visual zone should be reduced so that the pilot can comfortably communicate with said zones.

### SUMMARY OF THE DESCRIPTION

The subject matter of the present invention is to propose means of indirect interaction with visual zones of the cockpit of an aircraft which allow the pilot to perform the interactions in a particularly easy and comfortable manner, while making possible, the interaction with a very large number of visual zones in the cockpit.

To this end, the subject matter of the invention relates to a system for interacting with a plurality of visual zones forming a visual space of an aircraft pilot, every visual zone being identifiable by an identifier and controllable by an associated display unit.

The interaction system comprises a measurement module apt to generate a set of measurements characterizing every position and/or orientation of at least a part of the pilot’s body in a predetermined motor space; a pointing module apt to designate an active visual zone in the visual space using a transfer function, the transfer function associating with each set of measurements, the identifier of one of the visual zones of the visual space and an output module apt to send to the display unit associated with the visual zone, that activates an activation signal indicating the designation of said zone.

According to other advantageous aspects of the invention, the system comprises one or more of the following features, taken individually or according to any technically possible combination:
the transfer function further associates, a targeted point in the corresponding visual zone with every set of measurements;
the activation signal sent to the display unit associated with the active visual zone by the output module, further comprising the targeted point;
the motor space is defined by a zone of comfortable articulations of said part of the pilot’s body, preferentially the zone of comfortable articulations being determined by statistical data;
the part of the pilot’s body is selected from the group consisting of the head; at least one finger; and the eyes;
every set of measurements comprises an angle of rotation of said part of the pilot’s body along the pitch axis of the aircraft and an angle of rotation of said part of the pilot’s body along the yaw axis of the aircraft;
every visual zone corresponds to at least a part of a head-down display or a head-up display or of an augmented reality virtual display;
the system further comprises a voice recognition module apt to associate a voice command given by the pilot with a command signal as a function of a grammar associated with the active visual zone designated by the pointing module, and to further send said control signal to the display unit associated with the active visual zone;
the system further comprises a control unit apt to trigger the operation of the voice recognition module;
the system further comprises a storage module apt to store a visual zone designation history;
the voice recognition module is apt to associate a voice command given by the pilot with a control signal as a function of grammars associated with visual zones of the visual zone designation history;
the voice recognition module comprises a voice recognition engine apt to determine from the voice command given by the pilot, one or a plurality of recognized commands using one of the grammars and to associate with each of said commands a confidence rate depending on the grammar used;
the control signal is determined by analyzing the confidence rate(s).

The invention further relates to an interaction set in the cockpit of an aircraft comprising an interaction system as described above; a plurality of display units, every display unit being apt to control a visual zone which can be identified by an identifier, the set of visual zones forming a visual space.

According to other aspects of the invention, the set comprises one or more of the following features, taken individually or according to all technically possible combinations:
every display unit is apt to activate the corresponding visual zone in the event of reception of a corresponding activation signal from the output module (36) of the interaction system;
the transfer function further associates with every set of measurements, a targeted point in the corresponding visual zone;
every display unit is apt to further activate a sub-zone of the corresponding visual zone, according to the targeted point sent by the activation signal.

### BRIEF DESCRIPTION OF THE DRAWINGS

The features and advantages of the invention will appear upon reading the following description, given only as a non-limiting example, and making reference to the enclosed drawings, wherein:

FIG. 1 is a schematic view of a communication system according to the invention, the communication system comprising in particular, a communication system according to the invention;

FIG. 2 is a detailed schematic view of the interaction system shown in FIG. 1;

FIG. 3 is a schematic view illustrating the functioning the transfer function used by the interaction system shown in FIG. 2; and

FIGS. 4 and 5 are schematic views illustrating the operation of the interaction system shown in FIG. 2 for designating a plurality of visual zones.

### DETAILED DESCRIPTION OF EMBODIMENTS

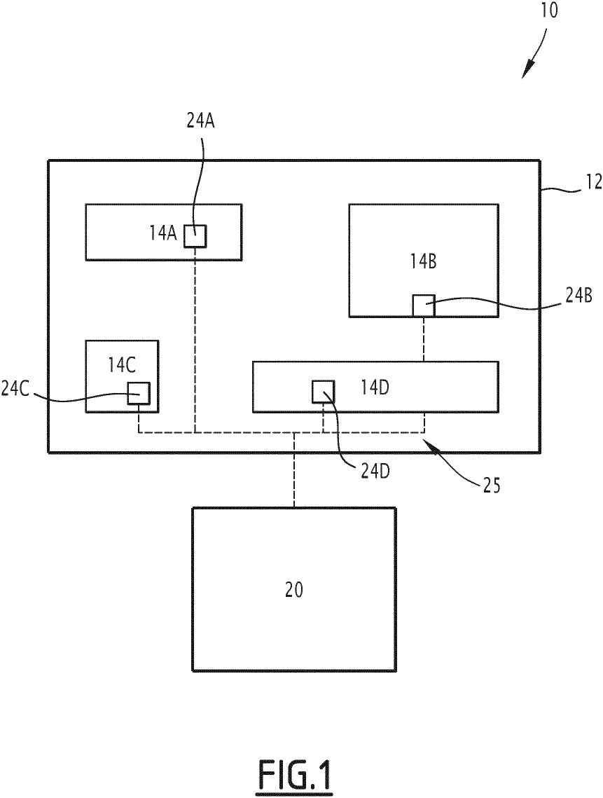

The interaction set 10 shown in FIG. 1 allows the crew of an aircraft to interact with a visual space 12.

Aircraft crew refers to one or more pilots controlling the flight of the aircraft from the aircraft cockpit.

In particular, in the example described hereinafter, it is considered that the cockpit is part of the aircraft as such.

According to other examples, the cockpit of the aircraft can be off-set from the aircraft. In such a case, the piloting of the aircraft is thus carried out remotely from the cockpit which is then formed by a command center located e.g. on the ground.

Hereinafter in the description, for the sake of simplicity, it is assumed that the crew consists of one pilot. However, it is clear that the invention remains applicable to any number of pilots.

The visual space 12 has a space situated in front of the pilot and said space advantageously extends at least partially around the latter, along at least one axis.

Such space can e.g. extend at an angle of less than 180° around the pilot about an axis corresponding to the yaw axis of the aircraft. According to another example, such visual space extends at an angle greater than 180° around the pilot about this same axis. In addition to said examples, the visual space can further extend at least partially around an axis corresponding to the pitch axis of the aircraft.

The visual space 12 includes a plurality of visual zones.

Every visual zone can be used for displaying for the pilot, information about the piloting of the aircraft.

In the example shown in FIG. 1, four visual zones, namely the visual zones 14A, 14B, 14C and 14D, are shown.

In the example of shown in said figure, the visual zones 14A to 14D are of different dimensions and are arranged next to each other so as to form a square.

Of course, other types of arrangement of said zones are further conceivable. It is possible e.g. to arrange the zones in a T-shape so that three visual zones are substantially aligned along a horizontal line and a fourth visual zone is arranged below the middle visual zone.

Every visual zone 14A to 14D corresponds e.g. to a display screen, e.g. a touch screen.

According to other examples, the visual zones 14A to 14D are de-correlated from the physical cockpit display screens.

In this way e.g. a visual zone can be shared between two or a plurality of display screens.

Furthermore, every visual zone can consist of one or a plurality of so-called head-down display screens or by one or a plurality of head-up or augmented display means.

According to yet another example, a visual zone can be shared between a head-down display screen and a head-up display means.

In all of said examples, the arrangement of the visual zones in the visual space 12 is known. Moreover, every visual zone can be identified by an identifier relating to said zone.

The position of every visual zone in the visual space 12 can be described e.g. by three-dimensional coordinates of at least one point of the zone or by two-dimensional coordinates when the visual space 12 is e.g. substantially flat.

Every visual zone may include one or more sub-zones. The sub-zones can be of a plurality of levels and correspond e.g. to particular functions of the corresponding embedded systems.

To enable the pilot to interact with the visual space 12, the interaction set 10 comprises an interaction system 20 and a plurality of display units.

Every display unit is associated with at least one visual zone and makes it possible to control the visual zone according to methods known per se.

In the example shown in FIG. 1, four visual units 24A, 24B, 24C and 24D are shown. In said example, every display unit 24A to 24D is associated with one of the visual zones 14A to 14D.

In said example, every display unit 24A to 24D thus makes it possible to control the visual zone 14A to 14D associated with same.

According to other examples, at least certain display units can be used for controlling a plurality of visual zones or at least parts of said visual zones.

The display units 24A to 24D are e.g. connected to the interaction system 20 by a computer network 25 which is also visible in FIG. 1.

As a variant, the display units 24A to 24D are connected to the interaction system 20 by any other means known per se.

Every display unit 24A to 24D is apt to receive signals from the interaction system 20 presenting e.g. different control commands for the visual zones 14A to 14D.

Said signals will be explained in more detail thereafter.

The display units 24A to 24D are also apt to receive signals coming from other embedded systems (not shown). Depending on said signals, the display units 24A to 24D can then be used for controlling the display of the visual zones 14A to 14D in a manner known per se.

Every display unit 24A to 24D is also apt to determine an identifier of a command grammar applicable to every visual zone and possibly to every sub-zone of the zone at a given moment.

In particular, “grammar” refers to a list of commands which are likely to be applied in relation to the corresponding visual zone or sub-zone. The identifier of such grammar can thus be used to determine same in a unique way.

Finally, at every moment, every display unit 24A to 24D is also apt to send to the interaction system 20, the identifier of the grammar which is associated with the zone and/or of the visual sub-zone active at said moment.

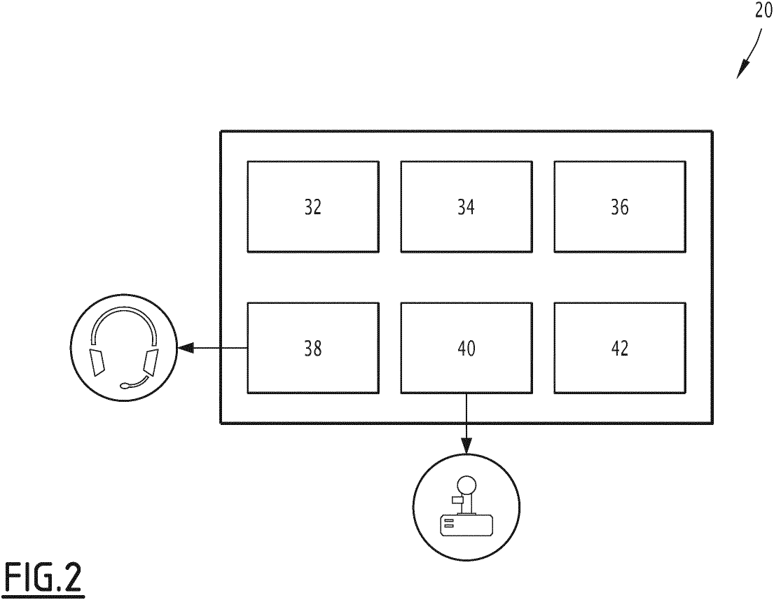

The interaction system 20 will henceforth be explained in greater detail with reference to FIG. 2.

Thus, as can be seen in FIG. 2, the interaction system 20 comprises a measurement module 32, a pointing module 34 and an output module 36.

Optionally, the interaction system 20 can further comprise a voice recognition module 38, a control element 40 and a storage module 42.

Said different modules will be explained hereinafter.

The measurement module 32 is apt to generate a set of measurements characterizing every position and/or orientation of at least a portion of the pilot’s body in a predetermined motor space.

Said part of the pilot’s body thus makes it possible to interact indirectly with the visual zones 14A to 14D, as will be explained thereafter.

According to different embodiments, said part of the body can comprise the head of the pilot and/or at least one finger and/or at least one eye of the pilot.

According to the invention, the motor space is defined by a comfortable articulation zone of said part of the pilot’s body.

The comfortable articulation zone is e.g. determined according to statistical data. According to another example, the comfortable articulation zone is e.g. determined by the pilot, e.g. by running corresponding tests. In the latter case, the motor space can thus be configured.

When said part of the pilot’s body is e.g. the head, the motor space can consist of the part of the cockpit wherein the pilot’s head is generally located, and bounded by comfortable articulation angles. Thus, such a space can e.g. extend from -65° to 65° around an axis corresponding to the yaw axis of the aircraft and from -30° to +30° around an axis corresponding to the pitch axis of the aircraft. Of course, said angles can vary as a function of the part of the body chosen.

In such a case, every set of measurements acquired by the measurement module 32 comprises e.g. an angle of rotation of said part along the pitch axis of the aircraft and an angle of rotation of said part along the yaw axis of the aircraft.

To acquire the corresponding measurements, the measurement module 32 is e.g. in the form of one or a plurality of cameras which are then oriented toward the pilot.

In particular, the term “camera” has to be understood in a broad sense and can e.g. include infrared cameras, high-precision cameras, etc.

The pointing module 34 is connected to the measurement module 32 and is apt to designate, among the visual zones 14A to 14D, an active visual zone using a predetermined transfer function.

In particular, “active visual zone” refers to a visual zone with which the pilot is interacting in order to introduce e.g. a corresponding piloting command.

E.g. when a visual zone is active, only said zone is apt to acquire piloting commands from the pilot.

In contrast, all other visual zones are said to be inactive.

Advantageously, the display unit 24A to 24D corresponding to the active visual zone can be used for displaying said zone differently in order to distinguish same from the other zones.

In such a case e.g. a particular color can be displayed around the active visual zone.

As a variant, the display units 14A to 14D corresponding to inactive visual zones can be used for displaying said zones in a different way in order to distinguish same from the active visual zone.

Thereby e.g. said display units can display said inactive visual zones with low brightness or with a particular color.

The transfer function implemented by the pointing module 32 makes it possible to associate every measurement set supplied by the measurement module 32 with the identifier of one of the visual zones 14A to 14D.

Furthermore, advantageously according to the invention, the transfer function makes it possible to associate every measurement set supplied by the measurement module 32 with a point targeted in the corresponding active visual zone. The targeted point can be used e.g. to designate an active sub-zone among all the sub-zones of the active zone.

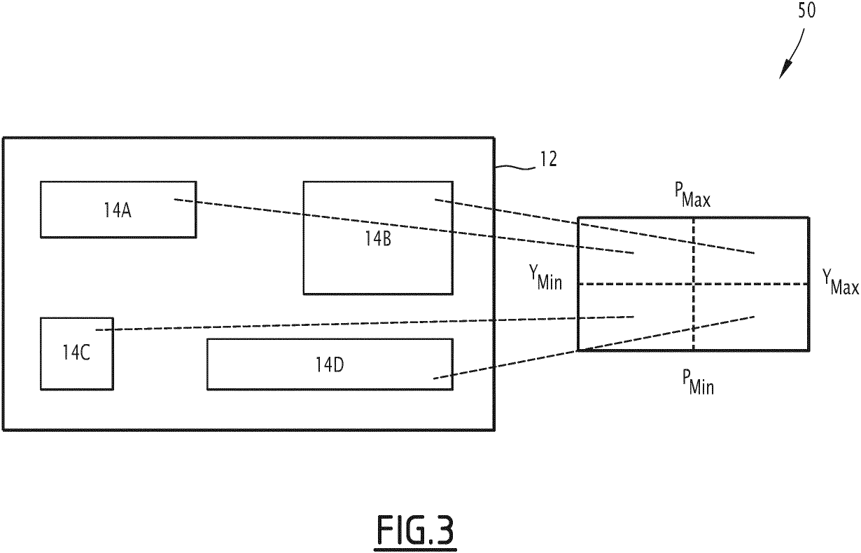

According to the invention, the transfer function makes it possible to project the motor space of the pilot onto the visual space 12, as illustrated in FIG. 3.

In the example shown in FIG. 3, the motor space identified in said figure by the reference 50 is divided e.g. into four equal parts. Each of said parts is associated with one of the visual zones 14A to 14D. E.g. any point in the motor space 50 between 0° and Ymax° and between 0° and Pmax° can refer to the visual zone 14B, every point between Ymin and 0° and between 0° and Pmax° can refer to the visual zone 14A, every point between Ymin° and 0° and 0° and Pmin° can refer to the visual zone 14C and every point between 0° and Ymax° and 0° and Pmin° can refer to the visual zone 14D. In said example, Pmax° and Ymax° are positive and Pmin° and Ymin° are negative.

Of course, other examples of transfer functions are further possible. E.g. when the measuring module 32 takes measurements relating to the movements of the pilot’s head, the corresponding transfer function can be adapted for take into account the inclination of the head when the head follows a horizontal straight line which drifts by the effect of perspective.

Advantageously, according to the invention, the pointing module 34 can define transfer functions of a plurality of levels.

Thus e.g. a first-level transfer function can return every point of the motor space to one of the visual zones 14A to 14D so as to designate an active visual zone among said zones.

Another so-called second-level transfer function can return every point of the motor space to a visual sub-zone of the active visual zone. It is thus possible to obtain a transfer function of n-th [level] where n=3, 4, etc.

In such case, the pointing module 34 can e.g. be configured for modifying the level of the transfer function used as a function of a predetermined event. Such event is implemented e.g. by the pilot and comprises e.g. the immobilization of said part of the body during a predetermined time interval or a pressing of a control button or further, a suitable voice command.

To implement the operation of the transfer function(s), the pilot module 34 is e.g. in the form of software or a programmable physical component such as an FPGA.

The output module 36 can be used for sending to the display unit 24A to 24D associated with the active visual zone 14A to 14D, an activation signal which then indicates the designation of said zone by the pointing module 34.

When the pointing module 34 can be further used for determining a targeted point in the corresponding visual zone, the corresponding activation signal sent to the corresponding display unit further comprises the coordinates of the targeted point or an identifier of the sub-zone corresponding to said targeted point.

Moreover, when the transfer functions of different levels are used, the activation signal is used for indicating the designation of a sub-zone of corresponding level.

To this end, the output module 36 is e.g. in the form of a network card connecting the pointing module 34 to every display unit 24A to 24D.

The voice recognition module 38 is apt to recognize a voice command given by the pilot and to associate a corresponding command signal with said command.

In particular, the voice recognition module 38 is apt to associate a voice command with the corresponding control signal depending on the active visual zone or the active visual sub-zone designated by the pointing module 34. To do this, the voice recognition module 38 is connected to every display unit 24A to 24D e.g. via the avionics network 25 so as to receive at every moment, the identifier of the grammar of the zone and/or of the visual sub-zone which is active at said moment.

As a variant, the voice recognition module 38 is apt to receive the information relating to every active visual zone and/or sub-zone from the pointing module 34 and to associate said information with the identifier of the corresponding grammar.

Upon receiving the identifier of the corresponding grammar, the voice recognition module 38 is apt to determine said grammar, e.g. in the internal memory thereof or in any other associated memory.

Then, upon detection of a voice command given by the pilot, the voice recognition module 38 is apt to recognize said command by using a voice recognition engine.

In particular, the voice recognition engine is apt to associate every voice command with one or a plurality of recognized commands with a confidence rate for every recognized command. Said rate is e.g. determined as a function of the correspondence of the recognized voice command with a command of the corresponding grammar.

Finally, depending on the result supplied by the voice recognition engine, the voice recognition module 38 is apt to generate the corresponding control signal and to send said control signal to the display unit 24A to 24D associated with the corresponding active visual zone 14A to 14D.

The control unit 40 enables the pilot to activate in particular, the operation of the voice recognition module 38.

Advantageously, according to the invention, said control element 40 is in the form of a single button which, when pressed by the pilot, is e.g. apt to activate the operation of the voice recognition module 38.

The storage module 42 is apt to store a visual zone designation history.

In particular, the storage module 42 can be used for storing a predetermined number of the identifiers of the grammars associated with the visual zones 14A to 14D and/or of the sub-zones activated one after the other. Such predetermined number is e.g. equal to three or four.

As a variant or in addition, the module 42 can be used for storing a predetermined number of the identifiers of the visual zones 14A to 14D and/or of the sub-zones activated one after the other, and for determining the identifiers of the grammars associated with said zones/sub-zones.

Furthermore, the storage module 42 is apt to supply the identifiers of the grammars stored or determined from the identifiers of the stored zones/sub-zones, to the voice recognition module 38 which is then apt to expand the grammar thereof which can be used for recognizing the voice command given by the pilot by the grammars of the set of identifiers stored by the storage module 42.

In particular, in such case, the voice recognition engine used by the module 38 is apt e.g. to associate every recognized command with a confidence rate also depending upon the grammar used to do so.

The operation of the interaction set 10 and more particularly of the interaction system 20 will henceforth be explained.

Initially, it is considered that e.g. the visual zone 14B is an active visual zone.

To designate a new active visual zone, the pilot turns e.g. the head toward the desired visual zone.

E.g. when the pilot wishes to designate the virtual zone 14A, the pilot turns the head slightly to the left and raises the head slightly with respect to the horizontal plane.

Said movement of the head is then detected by the measurement module 32 which generates a corresponding set of measurements and sends said set back to the pointing module 34.

By using the transfer function, the pointing module 34 determines that the set relates to the visual zone 14A.

Furthermore, when the set of measurements acquired by the measurement module 32 can be further used for determining a targeted point in the corresponding visual zone, the pointing module 34 further defines said point and, if applicable, the sub-zone corresponding to said targeted point.

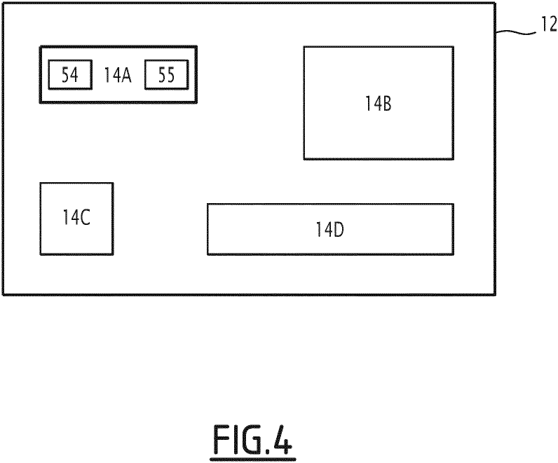

The output module 36 then sends to the display unit 24A which is associated with the visual zone 14A, an activation signal indicating the designation of said zone and possibly of the sub-zone corresponds to the targeted point. E.g. when the visual zone 14A comprises two sub-zones 54, 55 visible in FIG. 4 and when the targeted point corresponds to the sub-zone 55, the activation signal further comprises the designation of said sub-zone 55. Alternatively, the activation signal includes the coordinates of the targeted point, without the identifier of the corresponding sub-zone. In such case, the designation of the corresponding sub-zone is carried out by the display unit 24 depending on said coordinates.

Upon receipt of the activation signal, the display unit 14A designates the visual zone 14A as an active visual zone, instead of the visual zone 14B and possibly the sub-zone 55 thereof.

Alternatively, when transfer functions of a plurality of levels are used, the sub-zone 55 can be designated by a second level transfer function.

In such case, like in the previous case, the pointing module 34 designates the visual zone 14A using a first level transfer function in the manner similar to manner described hereinafter.

After a predetermined event, the pointing module 34 then modifies the level of the transfer function and then uses the second level transfer function. In such case, the pilot can designate one of the sub-zones 54, 55 either by turning the head to the left or to the right or e.g. his or her finger.

Finally, the output module 36 sends the activation signal of the corresponding sub-zone to the display unit 24A.

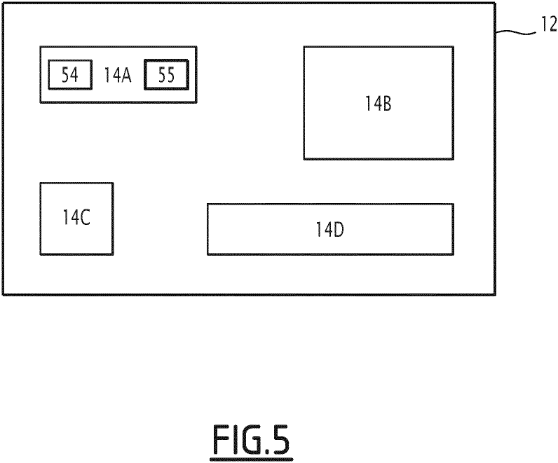

The display unit 24A then activates the corresponding sub-zone as illustrated in FIG. 5.

According to another embodiment, after having designated one of the visual zones, e.g. the visual zone 14A, the pilot actuates the control element 40.

After that, the control unit 40 then activates the voice recognition module 38 which switches to the mode of listening to the voice commands spoken by the pilot.

Furthermore, the voice recognition module 38 designates as active grammar, the grammar corresponding to the identifier of the grammar received from the corresponding display unit 24A to 24D, e.g. at the time of activation of the control unit 40

Moreover, when applicable, the voice recognition module 38 widens the active grammar thereof by grammars corresponding to the identifiers received from the storage module 42.

When the pilot announces the voice command, the voice recognition module 38 then recognizes said command by choosing e.g. the command having the highest confidence rate as determined by the voice recognition engine.

The voice command given by the pilot may e.g. designate the sub-zone 55 of the active visual zone 14A or any other action to be taken in relation to the visual zone 14A. For this purpose, a corresponding control signal is sent e.g. to the display unit 24A associated with the visual zone 14A.

Of course, the two aforementioned embodiments can be switched.

Thus, it is possible to designate the active visual zone as well as the active visual sub-zone by using the pointing module 34 as explained in relation to the first embodiment (with a targeted point or another transfer function) and then recognize a voice command associated with the active visual zone and/or sub-zone.

The present invention then has a certain number of advantages.

First of all, the invention makes it possible to interact with visual zones of the cockpit of an aircraft in a particularly simple way.

Indeed, the motor space associated with the corresponding part of the body can be adapted according to the articulations comfortable for the pilot.

Moreover, the invention makes it possible to set multimodal interactions combining voice and an indirect or supplementary designation mode for contextualizing voice commands.

In addition, the interaction system according to the invention makes it possible to store the history of the active visual zones and to take the history into account in order to avoid problems of desynchronization of the speech and of the designation movement of the pilot.

Furthermore, the implementation of a transfer function gives the possibility of designating non-homogeneous visual zones located on wide zones while taking into account the particular angles of discomfort.

Furthermore, the invention makes it possible to dynamically switch between different visual zones as well as sub-zones of said zones.

Finally, due to the invention, it becomes possible to easily reconfigure the visual zones of the cockpit. Such a reconfiguration can e.g. include the display of new visual zones/sub-zones on a half-screen or a full screen. Said zones/sub-zones can concern e.g. applications for mission management, piloting, radio communication control, systems management, display, etc.

The invention further makes it possible to set the parameters of the designated visual zones/sub-zones e.g. by head, by corresponding voice commands. Using voice commands, it is possible e.g. to adjust the zoom on a map, the control of the orientation of the map, whether or not displaying filters (display of flight plan, terrain, waypoints, traffic, superimposed synthetic vision, etc.), centering the map on a specific point, etc.

1. A system for interacting with a plurality of visual zones forming a visual space of an aircraft pilot, every visual zone being identifiable by an identifier and controllable by an associated display unit, the system comprising:
a measurer generating a set of measurements characterizing every position and/or orientation of at least a part of the pilot’s body in a predetermined motor space;
a pointer designating an active visual zone in the visual space using a transfer function, the transfer function associating every set of measurements with the identifier of one of the visual zones of the visual space;
an outputter sending to the display unit associated with the active visual zone an activation signal indicating designation of the active visual zone;
a storage storing a designation history of the visual zones;
a voice recognizer associating a voice command given by the pilot with a control signal depending on a grammar associated with the active visual zone designated by said pointer, and depending on the grammars associated with visual zones of the designation history of the visual zones, and to further send the control signal to the display unit associated with the active visual zone; and
a controller triggering operation of the voice recognizer.

2. The system according to claim 1, wherein the transfer function further associates every set of measurements with a targeted point in the corresponding visual zone; zone, and wherein the activation signal sent to the display unit associated with the active visual zone by said outputter further comprises the targeted point.

3. The system according to claim 1, wherein the motor space is defined by a comfortable articulation zone ofthe part of the pilot’s body.

4. The system according to claim 1, wherein the part of the pilot’s body is selected from a group consisting of the pilot’s head, at least one of the pilot’s fingers, and the pilot’s eyes.

5. The system according to claim 1, wherein every set of measurements includes an angle of rotation of the part of the pilot’s body along the pitch axis of the aircraft, and an angle of rotation of the part of the pilot’s body along the yaw axis of the aircraft.

6. The system according to claim 1, wherein every visual zone corresponds to at least a part of a head-down display or of a head-up display or of an augmented reality virtual display.

7. The system according to claim 1, wherein said voice recognizer comprises a voice recognition engine determining from the voice command given by the pilot, one or a plurality of recognized commands using one of the grammars and associating every command with a confidence rate depending on the grammar used, the control signal being determined by analyzing the confidence rate(s).

8. An interaction set in the cockpit of an aircraft comprising:
an interaction system according to claim 1, and
a plurality of display units, every display unit controlling a visual zone which may be identified by an identifier, the visual zones forming a visual space.

9. The interaction set according to claim 8, wherein every display unit activates the corresponding visual zone upon receiving a corresponding activation signal coming from the outputter of said interaction system.

10. The interaction setaccording to claim 9, wherein the transfer function further associates every set of measurements with a targeted point in the corresponding visual zone, and every display unit activates a sub-zone of the corresponding visual zone, according to the targeted point sent by the activation signal.

11. The system according to claim 3 wherein the comfortable articulation zone is determined by statistical data.
